(19) United States
(12) Patent Application Publication
(10) Pub. No.: US 2022/0413923 A1
(43) Pub. Date: Dec. 29, 2022

(54) SEAMLESS MICRO-SERVICES DATA SOURCE MIGRATION WITH MIRRORING

(71) Applicant: CHARTER COMMUNICATIONS OPERATING, LLC, St. Louis, MO (US)

(72) Inventors: Ramesh Mukkamala, Highlands Ranch, CO (US); Jacob Perlman, 1070 South Adams Street, CO (US)

(73) Assignee: CHARTER COMMUNICATIONS OPERATING, LLC, St. Louis, MO (US)

(21) Appl. No.: 17/357,202

(22) Filed: Jun. 24, 2021

(51) Int. Cl. G06F 9/50

(52) U.S. Cl. CPC G06F 9/5027

(57) ABSTRACT

Various embodiments comprise systems, methods, architectures, mechanisms and apparatus for migrating microservices supporting application requests in a production environment from an existing data source to a new data source in a manner tending to avoid applications or customers experiencing unexpected or undesirable results of microservices request processing. A second production environment mirroring relevant portions of the production environment and including microservices instantiated thereat coupled to a new data source processes microservices requests in parallel with production environment microservices coupled to an existing data source, the microservices of both environments generate output data, state information and the like, which is correlated to verify correct operation between the existing and new data sources.

### FIELD OF THE DISCLOSURE

The present disclosure generally relates to the electrical, electronic, and computer arts, and more particularly to management of microservices within a microservices architecture.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A microservices architecture is one in which one or more applications are structured as a collection of loosely coupled services organized around specific business functions that may be deployed, maintained, and tested independently. Advantageously, each of the services may communicate with other services through standardized application programming interfaces (APIs), enabling the services to be written in different languages or on different technologies. This technique avoids some of the problems associated with systems built as monolithic structures, where services are inextricably interlinked and can only be scaled together.

Applications implemented using a microservices architecture may use one or more backend data sources. For example, a network services provider may use multiple data sources for defining/maintaining customer subscription and billing information, defining/maintaining deployed provider equipment (PE) and customer premises equipment (CPE), managing the network and a variety of services provided there by as so on. The microservices and their data sources are critical to maintaining network Quality of Service (QoS) levels and customer Quality of Experience (QoE) levels.

Unfortunately, given the inherent complexity and loose coupling of the microservices and/or data sources, updating or modifying or changing data sources supporting the microservices may impact one or both of network QoS and customer QoE, such as when network and/or customer databases migrated to a new data source change functions of customer facing equipment or services. While such impacts are sometimes inevitable, it is desired to manage this process in a manner consistent with maintaining customer satisfaction.

### SUMMARY

Various deficiencies in the prior art are addressed by systems, methods, architectures, mechanisms and apparatus for migrating microservices supporting application requests in a production environment from an existing data source to a new data source in a manner tending to avoid applications or customers experiencing unexpected or undesirable results of microservices request processing. A second production environment mirroring relevant portions of the production environment and including microservices instantiated thereat coupled to a new data source processes microservices requests in parallel with production environment microservices coupled to an existing data source, the microservices of both environments generate output data, state information and the like, which is correlated to verify correct operation between the existing and new data sources.

A method according to one embodiment of managing microservices migration from existing to new data sources, comprises: identifying each microservice in a production environment configured to use an existing data source being replaced by a corresponding new data source; for each identified microservice, instantiating in a test environment a first container including the identified microservice configured to use the existing data source, and a second container including the identified microservice configured to use the new data source; for each identified microservice, contemporaneously processing in the test environment each of a sequence of relevant microservices requests at each of the corresponding first and second microservices to generate respective first and second microservices output data; for each identified microservice, comparing the first and second microservices output data to determine a level of correlation therebetween; and for each identified microservice, in response to the level of correlation exceeding a threshold level of correlation, determining that the identified microservice may process microservices requests in accordance with the new data source.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a block diagram of a system benefiting from embodiments of the invention;

FIG. 2 depicts a flow diagram of a method according to an embodiment.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Network operators, streaming media and cable television providers support various applications with microservices that are currently being used retrieve data from backend sources. When the source of that data is changing, the applications need to make sure that the data being sent to the service is the same as from the previous source, so that customers services are not impacted.

Various embodiments provide systems, apparatus, and methods configured to migrate a deployed application or portions thereof configured as one or more microservices interacting with an existing source of data (a backend captive or third party data source) to a new source of data in a manner tending to minimize any impact to customer Quality of Experience (QoE). For example, the application may include microservices interacting with an existing source of customer or subscriber data (e.g., such as associated with a services provider such as a network services provider, telecommunications provider, content provider, multiple-system operator (MSO) and the like) supported by old or legacy equipment to be upgraded or replaced.

For purposes of this discussion, it will be assumed that the provided services may comprise voice, video, data, and so on, that data implementing subscriber level agreements (SLAs) define subscribed services access levels/packages, guaranteed quality of service (QoS) levels and the like are defined in one or more customer/subscriber databases. Further, the services provider may maintain system map, provide equipment (PE) and customer premises equipment (CPE) state/status information in various databases. Further, the services provider may maintain services provisioning and delivery databases and other databases and data sets as needed to maintain the provider network/system and ensure that subscriber requirements for delivered services are met and billed appropriately. The data sources may include data sources generated by or captive to the network services provider, or data sources associated with third parties.

In general, the various embodiments address maintaining service continuity without degradation of subscriber QoE, and without changes to existing subscriber functions, channel lineup, service offerings and the like, even if such changes are consistent with the SLA (e.g., a subscriber has for some reason had access to one or more channels that are not part of their package). A preference is to make back end changes to data sources in a substantially seamless manner from the perspective of the subscribers, even if doing so results in a subscriber continuing to benefit from a service level beyond that which they have purchased. “Upselling” the subscriber to their currently enjoyed “excessive” service level, or explaining the loss of this service level to the subscriber, is to be handled by the service provider at a different time and/or by different means (i.e., deliberately as part of subscriber retention efforts, not in response to an unexpected service loss from the subscriber's perspective).

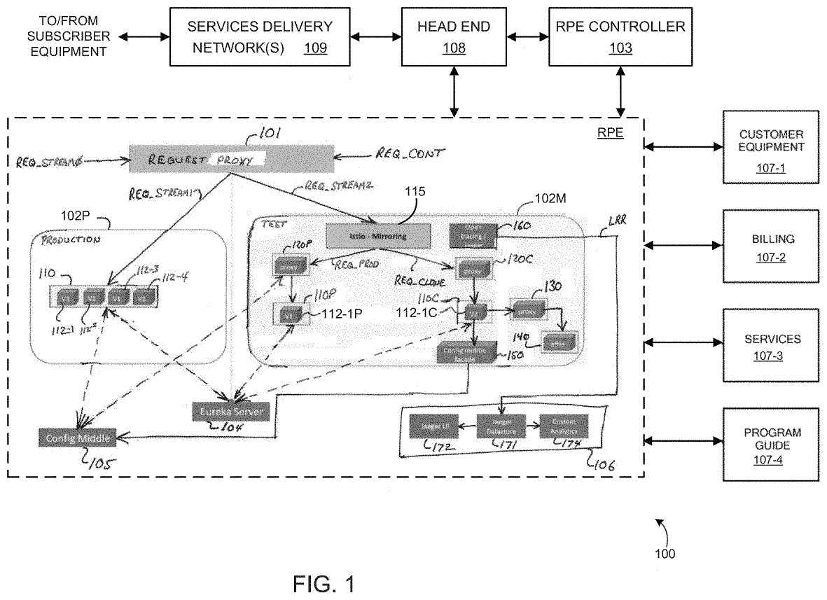

FIG. 1 depicts a block diagram of a system benefiting from embodiments of the invention. Specifically, FIG. 1 depicts provider equipment (PE) 100 configured to provide subscriber services via one or more services delivery networks such as the Internet, private network(s), access network(s) and the like 109. The various PE, subscriber services, and services delivery network(s) may be configured for use by a services provider such as a network services provider, telecommunications provider, content provider, multiple-system operator (MSO) and the like.

As depicted in FIG. 1, a head end 108 interacts with one or more services delivery network(s) 109 to perform various tasks associated with subscriber equipment authentication, network management, services delivery and the like. The head end 108 is configured to cooperate with request processing equipment (RPE) to receive and process various requests from subscriber equipment, such as pertaining to desired services, content, account changes, and so on. That is, a subscriber may make requests via subscriber equipment such as a mobile phone, a set-top box/remote, a laptop computer, a smart television, or some other network device, which requests are received/processed by the head end 108 and RPE. Subscriber requests generate transactions that are processed/validated via one or more support systems associated with the transaction. The head end 108 routes a stream REQ_STREAM0 of received subscriber requests and other requests to the RPE for further processing.

As depicted in FIG. 1, the RPE includes a request proxy 101 (e.g., a Zuul gateway, edge service, or similar enabling user access to various applications/services) that selectively routes incoming microservices requests REQ within the stream of such requests REQ_STREAM0 received from the head end 108 to one of a production environment 102P (as a production request stream REQ_STREAM1) or to a parallel production/mirror environment 102M (as a request stream REQ_STREAM2).

The production environment 102P and parallel production/mirror environment 102M may be implemented in a relatively standard manner using one or more dedicated computer servers, clusters of servers, an Infrastructure as a Service (IaaS) system, communications/interfacing mechanisms and the like, such as a computing environment providing memory and compute resources configured to instantiate virtual machines or containers configured to host software components such as microservices, applications, control modules and the like in accordance with the various functional elements described herein, which functional elements are suitable for by, illustratively, control and management systems associated with a network or media services provider (e.g., cable television, video on demand, internet services, telephony services, and/or other networking/communications services).

As depicted in FIG. 1, the production environment 102P may comprise a plurality of microservices container clusters 110 (only one cluster is depicted) configured to support production versions of each of a plurality of microservices 112. For simplicity, the microservices container cluster 110 of FIG. 1 is depicted as supporting four instantiated microservices in four respective containers (though more or fewer may be supported); namely, a first version V1 of each of four microservices 112-1 through 112-4, which microservices 112 are configured to process application requests within a stream of requests REQ_STREAM1 received from the request proxy 101. It is noted that more or fewer microservices may be instantiated, and that individual microservices instantiations may perform more function than identified herewith.

The various instantiated microservices 112, individually or in combination, are configured to process requests and responsively invoke and/or update various data storage or support systems. For example, the RPE is depicted as interacting with a plurality of data sources 107, illustratively, illustratively data sources associated with subscriber/customer equipment 107-1, subscriber/customer billing 107-2, subscriber/customer services 107-3, subscriber/customer program guide information 107-4 and/or other data sources. More of fewer data sources 107 may be used, the various data sources may be combined, and/or other data source(s) modifications may be employed as will be appreciated by those skilled in the art.

The microservices clusters 110 of the production environment 102P communicate with middleware 105 to return data to requesting applications. Specifically, for those microservices requests REQ for which data, state information, or some other result is to be returned to a requesting application, the returned data, state information, or some other result is passed from the relevant microservice(s) 112 to the requesting application via middleware 105 configured for this purpose.

The microservices clusters 110 of the production environment 102P communicate with a discovery server 104 (e.g., a Eureka Server or similar application) operable to store information pertaining to all client-service applications. Specifically, each of the microservices 112 within the production environment 102P is registered with the discovery server 104 so that the discovery server 104 is aware of the communications and other resources associated with the application requests used to invoke the various production environment microservices 112.

In a production environment 102P operating in a steady state manner (e.g., no pending or unresolved issues regarding a change in data source 107), all of the microservices requests REQ within the stream of microservices requests REQ_STREAM0 are routed to the production environment 102P for processing in accordance with the various microservices 112, which processing may responsively invoke and/or update data or state information stored in one or more of the data storage or support systems 107.

At times, one or more of the data storage or support systems 107 may be updated or changed in some manner that is not necessarily known to the production environment 102P. For example, an existing source(s) of customer or subscriber data may be supported by old or legacy equipment that is to be upgraded or replaced, or an existing data set is combined with another data set such as associated with a new service capacity or a new group of subscribers from an acquired company or service. In these and other instances, it is necessary to move or migrate request processing by the microservices 112 from a using the existing data storage or support systems 107 to the new data storage or support systems 107′.

Various embodiments provide mechanisms to effect such a move or migration of microservices 112 from existing to new data storage or support systems 107 in a manner tending to avoid impacting customer/subscriber quality of experience (QoE). Specifically, various embodiments provide a parallel production/mirror environment 102M configured to process some or all of the applications requests processed by the production environment 102P so that moving from an existing data source 107 to a new data source 107 do not result in applications or customers experiencing unexpected or undesirable results of microservices 112 request processing.

Various embodiments provide a test or parallel environment mirroring at least a relevant portion of a production environment and including microservices instantiated thereat coupled to a new data source and processing microservices requests in parallel with production environment microservices coupled to an existing data source, the microservices of both environments generating output data, state information and the like, which is correlated to verify correct operation between the existing and new data sources.

In some embodiments, the parallel production/mirror environment 102M using new data sources 107′ receives and processes at least a portion of the microservices requests received and processed by the production environment 102P using existing data sources 107. In these embodiments, the corresponding results of the production environment 102P and the parallel production/mirror environment 102M are compared or correlated to ensure proper operation with new data sources 107′.

In some embodiments, the parallel production/mirror environment 102M includes two processing paths; namely, an optional production processing path and a clone processing path. In these embodiments, the production processing path uses existing (deployed) data sources 107 and microservices versions to process microservices requests in the same manner as the production environment 102P, while the clone processing path uses new data sources 107′ and existing/deployed microservices versions to process microservices requests. In these embodiments, the corresponding results of the production processing paths and a clone processing paths within the parallel production/mirror environment 102M are compared or correlated to ensure proper operation with new data sources 107′. Optionally, new (not deployed) versions of the microservices may be used in the clone processing path, such for testing/verification of new versions, or modifications to existing versions so as to converge operation toward production microservices operations, and so on.

As depicted in FIG. 1, the parallel production/mirror environment 102M includes a microservices request mirroring tool 115 (e.g., Zuul or Istio) receiving the test request stream REQ_STREAM2 and responsively routing the microservices requests received thereby to each of two parallel request processing paths as a production path stream REQ_PROD and a clone path stream REQ_CLONE.

The production processing path is configured for processing microservices requests in substantially the same manner as that of the production environment 102P and using the relevant existing data source 107. The production versions of the microservices (e.g., V1) are also used. This path is optional in embodiments where the results of production environment processing are compared to the results of the second path.

The production processing path comprises a request proxy 120P configured to receive the production path stream REQ_PROD from the microservices request mirroring tool 115, and forward the microservices requests therein to one or more microservices clusters 110P (only one cluster is depicted) configured to support production versions of each of the relevant microservices 112 (illustratively a single microservice 112-1P) operably coupled to one or more existing data sources 107. The microservices cluster(s) 110P communicate with the middleware 105 to return data to requesting applications, and with the discovery server 104 which operates to register the relevant microservice(s) (e.g., 112-1P).

The clone processing path is configured for processing microservices requests in substantially the same manner as that of the production environment 102P, except that relevant new data sources 107′ are used instead of the existing data sources 107 used in the production environment 102P or the optional production processing path of the parallel production/mirror environment 102M.

The clone processing path comprises a request proxy 120C configured to receive the clone path stream REQ_CLONE from the microservices request mirroring tool 115, and forward the microservices requests therein to one or more microservices clusters 110C (only one cluster is depicted) configured to support production versions or new versions of each of the relevant microservices 112 (illustratively a new version V2 of a single microservice 112-1C) operably coupled to one or more new data sources 107′. The microservices cluster(s) 110C communicate with a middleware façade 150 (not directly with middleware 105) configured to selectively return data to requesting applications via middleware 105, and with the discovery server 104 which operates to register the relevant microservice(s) (e.g., 112-1C).

As depicted in FIG. 1, a distributed tracing mechanism 106, such as a Jaeger transaction tracing system, is configured for tracing transactions between distributed services to gain visibility to an entire chain of events associated with a complex interaction between microservices to support the monitoring and troubleshooting of complex microservices environments. That is, the path of a request through different microservices may be followed, visualized, and generally organized in a manner enabling debugging and optimization of the various transactions supporting the request. Various tools may be employed to monitor distributed transactions, optimize performance and latency, and perform root cause analysis (RCA) of any problems encountered. As depicted, the distributed tracing mechanism 106 comprises a data storage module 171 configured for storing tracing transaction data received from a tracing module 160 within the parallel production/mirror environment 102M, a user interface (UI) 172 configured for generating and optionally displaying visualizations of traced microservices transactions/flows, and an analytics module 174 configured for processing traced microservices transactions/flows to derive operational, statistical, and/or other data therefrom. Optionally, an additional proxy 130 may be placed before the new data source 107′ (such as the new data source denoted as effie 140 in FIG. 1) to retrieve the data.

Generally speaking, the various embodiments provide a mirror or parallel environment capable of processing microservices requests associated with production environment microservices executed within containers instantiated within a production environment.

In various embodiments, the RPE 103 (or components therein such as the middleware 105, discovery server 104, middleware façade 150 and so on), the head end 108, or some other processing element(s) or module(s) capable of performing a relevant data comparison function may be used to compare output data of each of first and second instantiations of a microservice of interest, where each instantiation is contemporaneously processing the same microservices requests, and where the first instantiation is coupled to an existing data source and the second instantiation is coupled to a new data source. In this manner, a determination may be made as to whether a correlation of such output data is indicative of correct processing of the microservice requests by the second instantiation so as to deem the new data source acceptable for use by an instantiation of the microservice of interest. If acceptable, then a migration toward using the new data source instead of the existing data source may be invoked.

Various embodiments comprise a system for processing microservices requests. The system includes a production environment including compute and memory resources configured as one or more clusters of containers hosting microservices including an identified microservice operatively coupled to an existing data source, the existing data source scheduled to be replaced by a new data source, and an environment mirroring at least a portion of the production environment, the mirroring environment including compute and memory resources configured as a first container for hosting a first instantiation of the identified microservice operatively coupled to the existing data source, and a second container for hosting a second instantiation of the identified microservice operatively coupled to the new data source.

The system further includes one or more modules/components configured to receive and compare output data of microservices requests contemporaneously processed by each of the first and second instantiations of the identified microservice to determine thereby a level of correlation. In response to the level of correlation exceeding a threshold level of correlation, the system may invoke a production environment migration of microservice request processing from an instantiation of the identified microservice operatively coupled to the existing data source toward an instantiation of the identified microservice operatively coupled to the new data source.

Various elements or portions thereof depicted in FIG. 1 and having functions described herein are implemented at least in part as computing devices having communications capabilities, computing capabilities, storage capabilities, input/output capabilities and the. These elements or portions thereof may comprise computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using network services provider equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The network services provider equipment may also be used to provide some or all of the various other functions described herein.

As such, the various functions depicted and described herein may be implemented at the elements or portions thereof as hardware or a combination of software and hardware, such as by using a general purpose computer(s), data center(s), one or more application specific integrated circuits (ASIC), and/or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

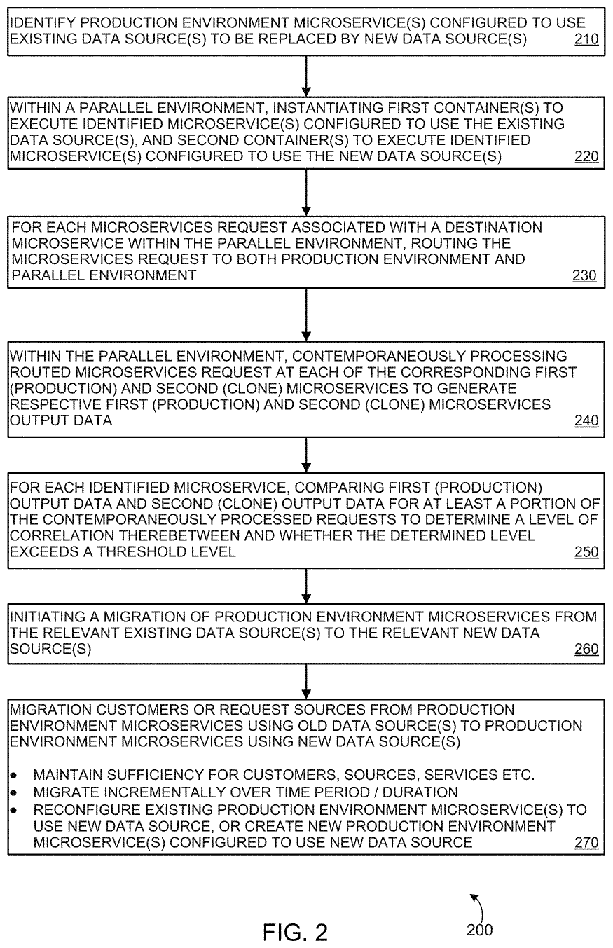

FIG. 2 depicts a flow diagram of a method according to an embodiment. Specifically, the method 200 of FIG. 2 is suitable for use managing the migration of production environment microservices from existing data source(s) to new data source(s), such as a change in a data source 107 as discussed above with respect to FIG. 1.

The method 200 of FIG. 2 may be implemented by a controller or distributed control function(s) associated with or cooperating with request processing equipment (RPE), such as the RPE controller 103 depicted above with respect to FIG. 1, by control functions in a head end 108, by a management entity for a network or data center, and so on. The controller may comprise a virtual controller instantiated within a production and/or test/parallel environment, a dedicated controller, or some other control device/means configured to perform the various functions as described herein with respect to the figures.

At step 210, the method identifies production environment microservices configured to use one or more relevant existing data sources that are to be updated/changed (i.e., to be replaced by one or more relevant new data sources). Some microservices may use a single data source, while some may use more than one data source.

For example, in the case of updating/changing the data source associated with customer equipment 107-1 (or some other data source), at step 210 the controller operates to identify within the production environment those specific instantiated microservices 112 executed within the cluster of containers 110 which use, update, and/or require information from the data source to be replaced (the customer equipment data source 107-1 in this example).

At step 220, the method instantiates one or more first containers to execute therein identified microservice(s) operatively connected to the relevant existing data source (e.g., existing data source 107-1), and instantiates one or more second containers to execute therein identified microservice(s) operatively connected to the relevant new data source (e.g., data source replacing existing data source 107-1).

For example, in the case of updating/changing the data source associated with customer equipment 107-1 impacting production environment microservice 112-1, at step 220 there is instantiated within the parallel production/mirror environment 102M a first container 110P for executing therein the identified microservice 112-1 as a production microservice 112-1P operatively connected to the existing data source 107-1. Further at step 220 there is instantiated within the parallel production/mirror environment 102M a second container 110C for executing therein the identified microservice 112-1 as a clone microservice 112-1C operatively connected to the data source replacing existing data source 107-1 (e.g., data source 107′-1).

At step 230, each microservices request REQ received within a microservices request stream REQ-STREAM0 to be processed by a production environment microservice identified at step 210 is also routed to the corresponding production and clone microservices instantiated within the parallel environment.

Further to the example, microservices requests to be routed to the production environment 102P for processing by microservice 112-1 are also routed to the parallel production/mirror environment 102M for processing by microservice 112-1P and 112-1C.

At step 240, for each microservices request (such as in a sequence or stream of relevant requests) routed to production and clone microservices within the parallel environment, contemporaneously processing microservices request at each of the corresponding first (production) and second (clone) microservices to generate respective first (production) and second (clone) microservices output data. The first (production) and second (clone) microservices output data may be stored in a controller, in either data source, or in any other place for subsequent use.

The first (production) output data corresponds to data/state updates, changes and the like, as well as microservices request return values, commands, and/or any other operational impact associated with the clone microservices instantiation using the existing data source to process the request.

The second (clone) output data corresponds to data/state updates, changes and the like, as well as microservices request return values, commands, and/or any other operational impact associated with the clone microservices instantiation using the new data source to process the request.

Further to the example, 112-1 relevant microservices requests are contemporaneously processed in the test/parallel environment by the first (production) container microservice 112-1P and second (clone) container microservice 112-1C to produce, respectively, first (production) output data and second (clone) output data.

At step 250, for each identified microservice instantiated as production and clone microservices at the test/parallel environment, comparing first (production) output data and second (clone) output data for at least a portion of the contemporaneously processed requests to determine a level of correlation therebetween, and whether that level of correlation exceeds a threshold level of correlation deemed to be sufficient to allow migration of the identified production environment microservice from the existing data source to the new data source. That is, determining that the identified microservice may process be configured to process microservices requests in accordance with the new data source

The portion may comprise requests associated with some or all of service subscribers associated with a high service level or tier (e.g., platinum, gold, silver, bronze), non-critical or unimportant information/functions, lower priority services or traffic flows, and so on.

Correlation may comprise an element-be-element comparison of each change in the first (production) output data to a hopefully corresponding change in the second (clone) output data. Correlation may be defined in various ways, and since certain portions of the data set are more important than other portions, some embodiments contemplate correlating only the important portions of the various data sets.

A substantially 100% correlation level is indicative of the second (clone) container microservice, which is couple to the new data source, operating substantially identically to the first (production) container microservice which is couple to the existing data source.

A 100% correlation level, or some other threshold correlation level (e.g., 98%, 95%, 90%, 80%) may be deemed “sufficient” to indicate that the relevant production environment microservice may be reconfigured to stop using the old data source 107 and start using the new data source 107′.

The “sufficiency” of the correlation level may be absolute or data-independent (i.e., considers all parallel environment microservices output data).

The “sufficiency” of the correlation level may be based on particular types of output data deemed to be more important or otherwise relevant to the data source migration. For example, some state data or other data may be inconsistent between the first (production) output data and second (clone) output data, but the inconsistency is not relevant to the user experience or to proper billing, or the inconsistency may be avoided by forcing a reboot of provider or subscriber equipment, or by performing some other action to mitigate against any problems due to such an inconsistency.

Further to the example, 112-1 relevant microservices requests resulting in first (production) output data and second (clone) output data are compared to determine if processing the microservices requests using the new data source result in outcomes that are too different than processing the same microservices requests using the old data source, wherein the amount of difference is the correlation between the two output data sets.

At step 260, in response to correlations exceeding the threshold level, or the relevant threshold levels for the types of customers, services, data and the like deemed important, a migration of customers and/or other sources of microservices requests is initiated. Migration comprises the process of changing the way the relevant microservices requests are handled by quickly or slowly routing an ever increasing portion of relevant microservices requests from a microservices instance using the old data source to a corresponding microservices instance using the new data source.

At step 270, the migration of customers or request sources from production environment microservices using old data source(s) to production environment microservices using new data source(s) occurs in a manner that maintain correlation sufficiency for the customers, sources, services and the like being migrated. The migration may occur incrementally over time period/duration. The migration may ultimately result in a reconfigure of existing production environment microservice(s) to use a new data source, or a create new production environment microservice(s) configured to use new data source.

For example, in response to a determination that an identified microservice may process microservices requests in accordance with the new data source, portions of a production request stream (e.g., REQ_STREAM0) comprising requests for the identified microservice may be divided into a first request stream (e.g., REQ_STREAM1) for processing by the production environment and a second request stream (e.g., REQ_STREAM2) for processing by the test environment, wherein the first request stream is initially much larger than the second request stream (e.g., ×10 larger, 95% to 5%, etc.). Generally speaking, the percentage of first stream with respect to the second stream depends on the overall volume of the production traffic and can be up to 100% if the first stream is processing very critical data.

For an identified microservice migration, at the test environment, in response to the contemporaneous processing at each of the corresponding first and second microservices instantiated therein of a second request stream of identified microservice requests resulting in a level of correlation exceeding the threshold level of correlation, using the second microservices request processing as the production processing of the identified microservices requests.

For an identified microservice migration, after a time period during which only the second microservices request processing is used as the production processing of the identified microservices requests, increasing the size of the corresponding second request stream and decreasing the size of the corresponding first request stream.

For an identified microservice migration, after each of a plurality of time periods during which only the second microservices request processing is used as the production processing of the identified microservices requests, increasing the size of the corresponding second request stream and decreasing the size of the corresponding first request stream. The stream sizes may be increased or decreased by predetermine percentages such as approximately 1%, 5%, 10%, or some other percentage. The increase and decrease of size (volume) of the first and second request streams may be adapted in response to the criticality of the services being processed.

The time periods may comprise approximately 1, 5, 10, 20, 40, 60, 90 seconds, 1, 5, 10, 20, 40, 60, 90 hours, or some other time period. The time periods may vary from seconds to hours to days depending on the criticality of services, wherein higher priority or critical services may be given preferential treatment over lower priority or non-critical services. For example, in various embodiments, apportionment of a production request stream between the first request stream (production) and second request stream (mirror) is adapted in response to at least one of overall volume of production request traffic and the percentage of production requests therein deemed to be critical.

Generally speaking, a migration of production environment microservices from the relevant existing data sources to the relevant new data sources occurs over time as an increasing portion of received requests are processed using instantiated microservices using new data sources and a decreasing portion of received requests are processed using instantiated microservices using existing data sources. This transition may occur instantly wherein the relevant production microservice is pointed to the new data source such that all processing by the relevant production microservice uses the new data source.

For example, in the case of updating/changing the data source associated with customer equipment 107-1 impacting production environment microservice 112-1, a first but decreasing portion of the requests are processed by a microservice using the existing data source (e.g., the existing production environment microservice or the second group microservice of the parallel environment), and a second but increasing portion of the requests using the new data source (e.g., the first group microservice of the parallel environment). After a predetermined amount of time, or at a low activity portion of the day, the production environment microservice may be directed to utilize the new data source(s) such that the migration is now complete.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method of managing microservices migration from existing to new data sources, comprising:
identifying each microservice in a production environment configured to use an existing data source being replaced by a corresponding new data source;
for each identified microservice, instantiating in an environment mirroring at least a portion of the production environment a first container including the identified microservice configured to use the existing data source, and a second container including the identified microservice configured to use the new data source;
for each identified microservice, contemporaneously processing in the mirroring environment each of a sequence of relevant microservices requests at each of the corresponding first and second microservices to generate respective first and second microservices output data;
for each identified microservice, comparing the first and second microservices output data to determine a level of correlation therebetween; and
for each identified microservice, in response to the level of correlation exceeding a threshold level of correlation, determining that the identified microservice may process microservices requests in accordance with the new data source.

2. The method of claim 1, wherein the sequence of relevant microservices requests processed by mirroring environment instantiations of an identified microservice are also processed by the corresponding production environment microservice.

3. The method of claim 1, further comprising:
in response to a determination that an identified microservice may process microservices requests in accordance with the new data source, dividing a production request stream for the identified microservice into a first request stream for processing by the production environment and a second request stream for processing by the mirroring environment, wherein the first request stream is larger than the second request stream.

4. The method of claim 3, wherein the first request stream is at least ten times larger than the second request stream.

5. The method of claim 3, wherein the first request stream is approximately 95% of the production request stream and the second request stream is approximately 5% of the production request stream.

6. The method of claim 5, wherein apportionment of the production request stream between the first request stream and second request stream is adapted in response to at least one of overall volume of production request traffic and the percentage of production requests therein deemed to be critical.

7. The method of claim 3, further comprising:
at the mirroring environment, in response to the contemporaneous processing at each of the corresponding first and second microservices instantiated therein of a second request stream of identified microservice requests resulting in a level of correlation exceeding the threshold level of correlation, using the second microservices request processing as the production processing of the identified microservices requests.

8. The method of claim 7, further comprising:
for an identified microservice, after a time period during which only the second microservices request processing is used as the production processing of the identified microservices requests, increasing the size of the corresponding second request stream and decreasing the size of the corresponding first request stream.

9. The method of claim 7, further comprising:
for an identified microservice, after each of a plurality of time periods during which only the second microservices request processing is used as the production processing of the identified microservices requests, increasing the size of the corresponding second request stream and decreasing the size of the corresponding first request stream.

10. The method of claim 9, wherein stream sizes are increased or decreased by predetermine percentages of at least one of approximately 1%, 5%, or 10%.

11. The method of claim 9, wherein time periods comprise at least one of approximately 1, 5, 10, 20, 40, 60, and 90 seconds.

12. The method of claim 8, wherein time periods comprise at least one of approximately 1, 5, 10, 20, 40, 60, and 90 hours.

13. The method of claim 9, further comprising:
in response to a size of a second request stream of a divided production request stream for an identified microservice reaching substantially 100%, configuring the identified microservice in the production environment to use the new data source.

14. The method of claim 13, further comprising:
terminating the processing of request for the identified microservice by the mirroring environment.

15. An apparatus for servicing microservices requests in a production environment, the production environment comprising compute and memory resources configured as one or more clusters of containers hosting microservices including an identified microservice operatively coupled to an existing data source, the existing data source scheduled to be replaced by a new data source, the apparatus comprising:
compute and memory resources, in an environment mirroring at least a portion of the production environment, configured as a first container and hosting a first instantiation of the identified microservice operatively coupled to the existing data source;
compute and memory resources, in the mirroring environment, configured as a second container and hosting a second instantiation of the identified microservice operatively coupled to the new data source; and
compute and memory resources configured to compare output data of microservices requests contemporaneously processed by each of the first and second instantiations of the identified microservice to determine a level of correlation therebetween and, in response to the level of correlation exceeding a threshold level of correlation, invoking a production environment migration of microservice request processing from an instantiation of the identified microservice operatively coupled to the existing data source toward an instantiation of the identified microservice operatively coupled to the new data source.

16. The apparatus of claim 15, wherein the sequence of relevant microservices requests processed by mirroring environment instantiations of an identified microservice are also processed by the corresponding production environment microservice.

17. The apparatus of claim 15, wherein the production environment migration comprises dividing a production request stream for the identified microservice into a first request stream for processing by the instantiation of the identified microservice operatively coupled to the existing data source and a second request stream for processing by the instantiation of the identified microservice operatively coupled to the new data source.

18. The apparatus of claim 17, wherein apportionment of the production request stream between the first request stream and second request stream is adapted in response to at least one of overall volume of production request traffic and the percentage of production requests therein deemed to be critical.

19. The apparatus of claim 17, wherein the instantiation of the identified microservice operatively coupled to the existing data source is within a container in the production environment, and the instantiation of the identified microservice operatively coupled to the new data source is within a container in the production.

20. A system for processing microservices requests, comprising:
a production environment including compute and memory resources configured as one or more clusters of containers hosting microservices including an identified microservice operatively coupled to an existing data source, the existing data source scheduled to be replaced by a new data source; and
an environment mirroring at least a portion of the production environment, the mirroring environment including compute and memory resources configured as a first container for hosting a first instantiation of the identified microservice operatively coupled to the existing data source, and a second container for hosting a second instantiation of the identified microservice operatively coupled to the new data source;
wherein output data of microservices requests contemporaneously processed by each of the first and second instantiations of the identified microservice are compared to determine a level of correlation therebetween and, in response to the level of correlation exceeding a threshold level of correlation, invoking a production environment migration of microservice request processing from an instantiation of the identified microservice operatively coupled to the existing data source toward an instantiation of the identified microservice operatively coupled to the new data source.
